(19) United States
(12) Patent Application Publication
(10) Pub. No.: US 2025/0378611 A1
(43) Pub. Date: Dec. 11, 2025

(54) ALGORITHMIC CONTENT GENERATION

(71) Applicant: Apple Inc., Cupertino, CA (US)

(72) Inventors: Ada TURNER, Oakland, CA (US); Alexander W. JOHNSTON, Los Angeles, CA (US)

(21) Appl. No.: 19/199,144

(22) Filed: May 5, 2025

Related U.S. Application Data
(60) Provisional application No. 63/657,538, filed on Jun. 7, 2024.

(51) Int. Cl. G06T 13/00; G06F 3/0484

(52) U.S. Cl. CPC G06T 13/00; G06F 3/0484

(57) ABSTRACT

Some embodiments described in this disclosure are directed to generating an algorithmic screensaver (or other content). In some embodiments, the algorithm includes detecting a first event for transitioning a generated algorithmic screensaver for an electronic device from a first scene to a second scene, different from the first scene. In some embodiments, the algorithm includes determining a first scene type of the first scene. In some embodiments, the algorithm includes determining a second scene type of the second scene. In some embodiments, the algorithm includes selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition.

### CROSS REFERENCE TO RELATED APPLICATIONS

This application claims the benefit of U.S. Provisional Application No. 63/657,538, filed Jun. 7, 2024, the content of which is herein incorporated by reference in its entirety for all purposes.

### FIELD OF THE DISCLOSURE

This relates generally to generation of algorithmic content.

### BACKGROUND

User interaction with electronic devices has increased significantly in recent years. These devices can be devices such as computers, tablet computers, televisions, multimedia devices, mobile devices, and the like.

In some circumstances, such a device presents content to a user, such as an algorithmic screensaver. In some circumstances, it would be beneficial for the algorithmic content to be based on the context of such a device. Enhancing the generation of algorithmic content reduces the need for user input for generating the algorithmic content, which is particularly important where devices are battery-operated.

### SUMMARY

Some embodiments described in this disclosure are directed to one or more methods for generating algorithmic content, such as a screensaver, for an electronic device. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6L illustrate exemplary ways of generating algorithmic content for a device in accordance with some embodiments of the disclosure.

FIG. 7 is a flow diagram illustrating a method of generating algorithmic content for a device in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Providing efficient ways of generating algorithmic content for a device enhances user interactions with the device by reducing the time and inputs needed to generate such content and reducing user errors-which further reduces the computing resources needed to generate and/or display the algorithmic content. In some embodiments, the algorithm for generating the algorithmic content includes detecting a first event for transitioning a generated algorithmic screensaver for an electronic device from a first scene to a second scene, different from the first scene. In some embodiments, the algorithm includes determining a first scene type of the first scene. In some embodiments, the algorithm includes determining a second scene type of the second scene. In some embodiments, the algorithm includes selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

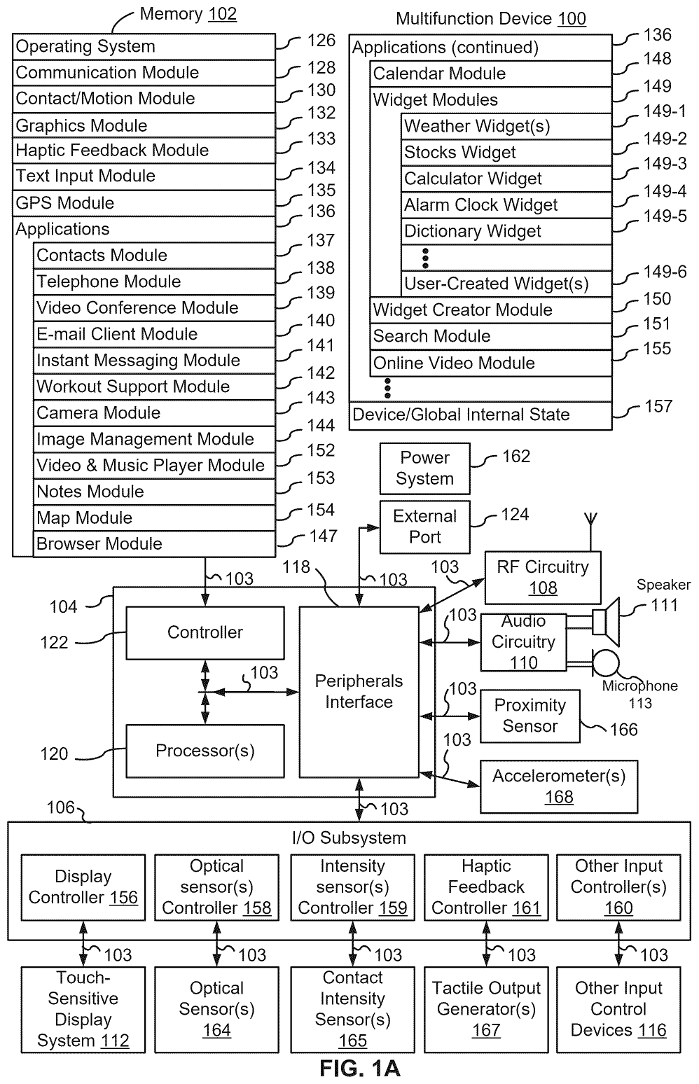

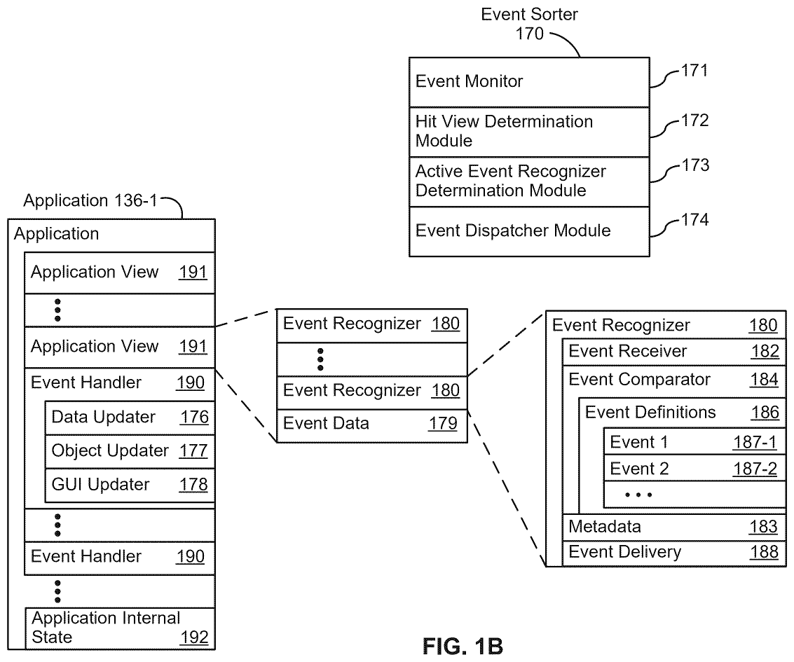

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

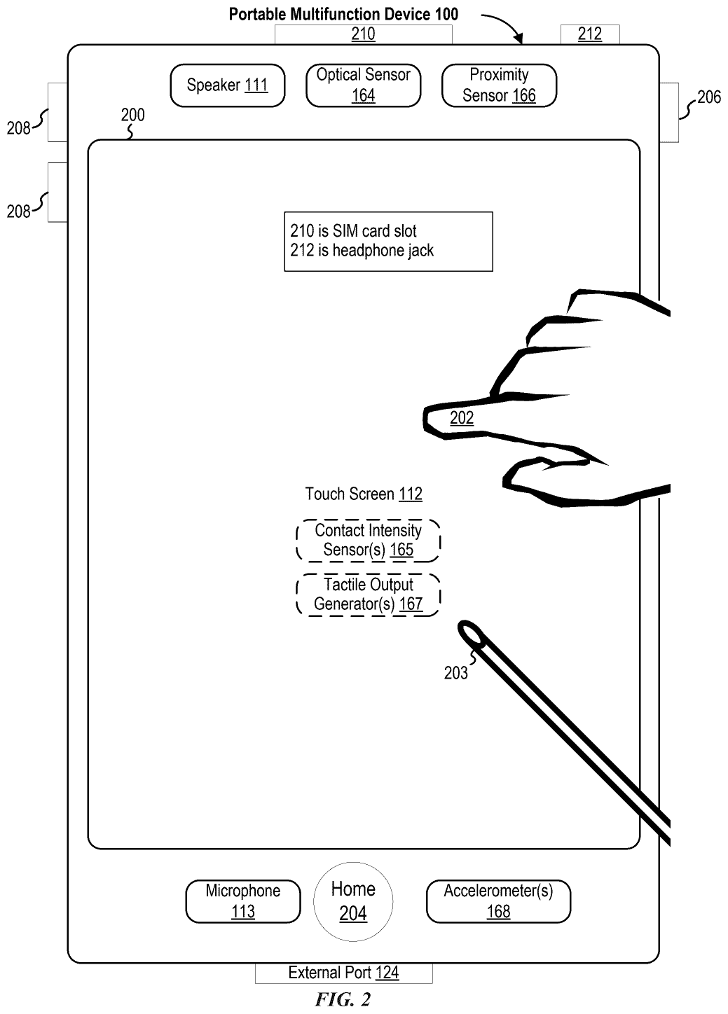

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

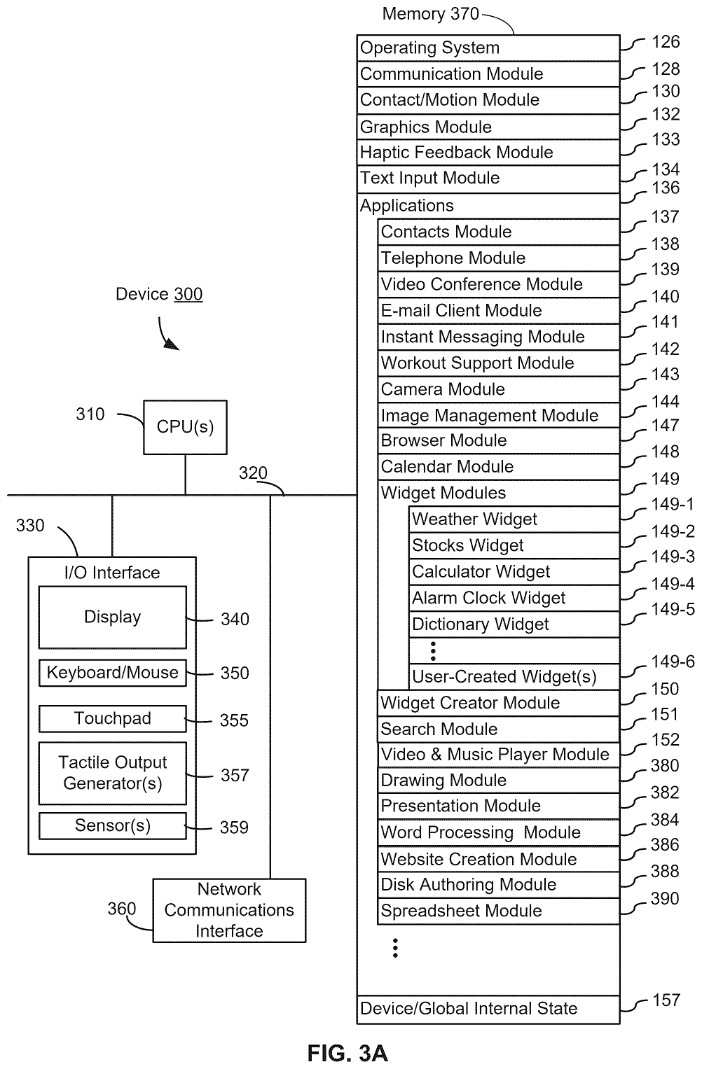

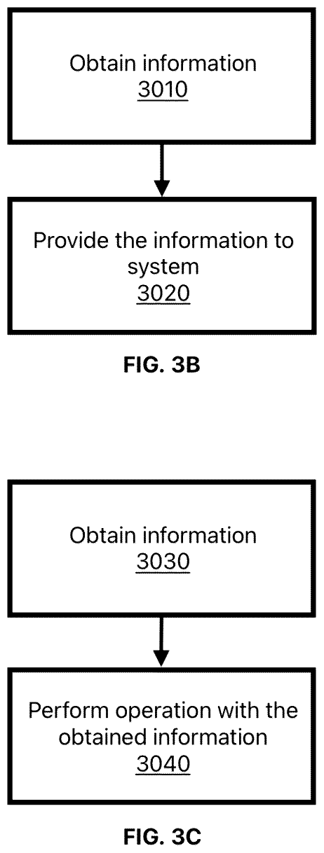

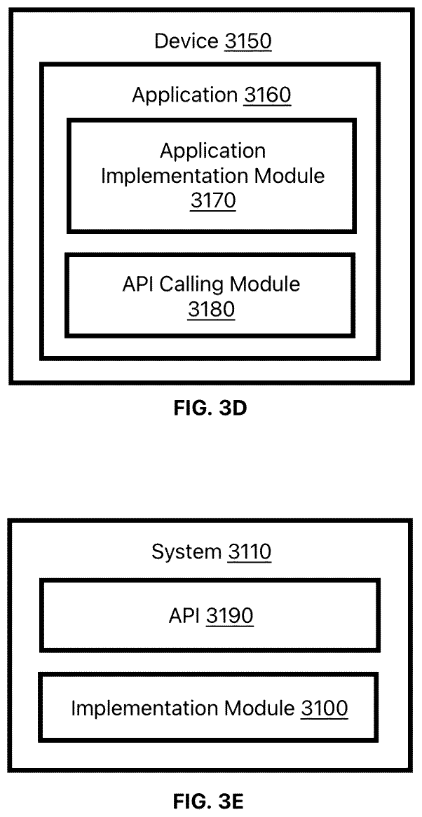

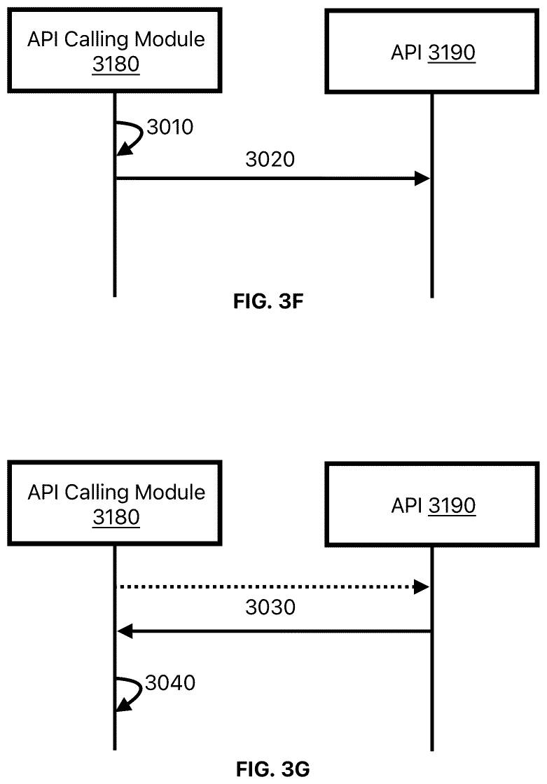

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 31E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is an system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

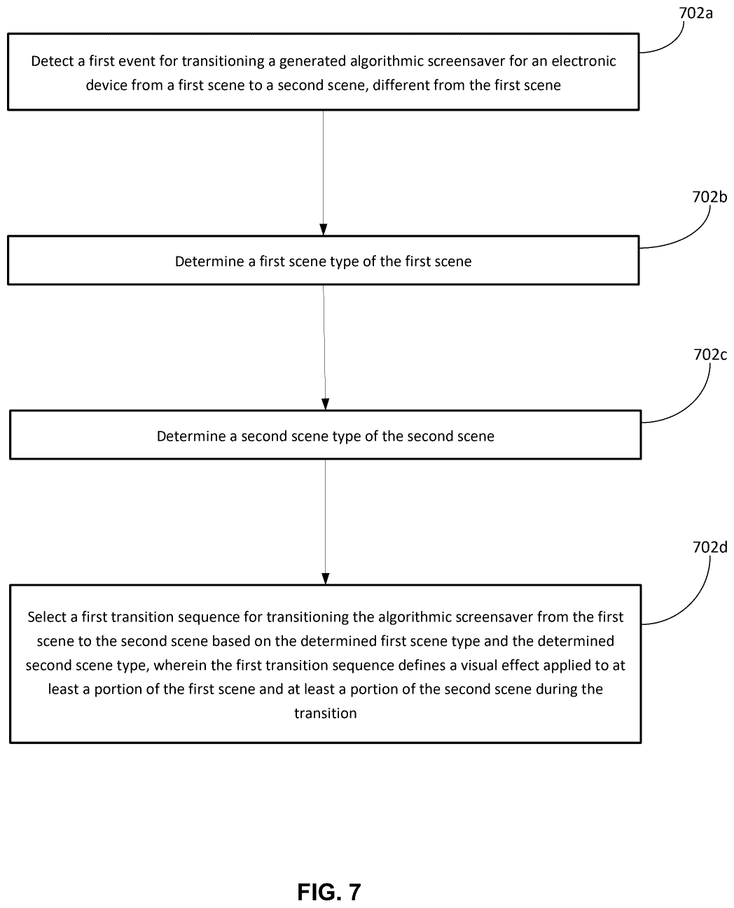

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API calling module 3190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

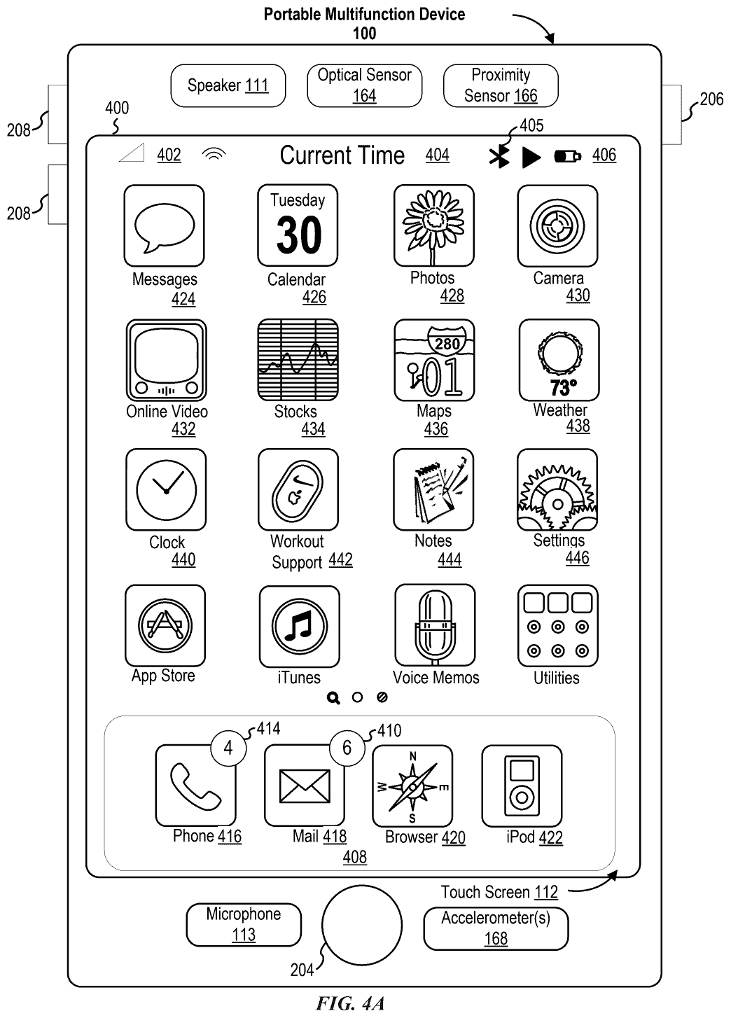

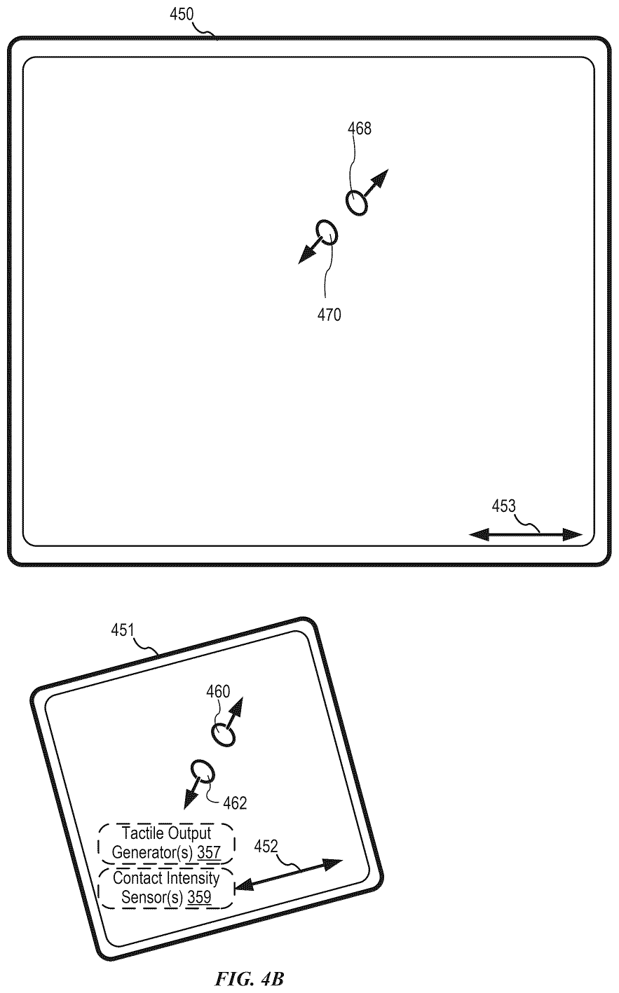

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

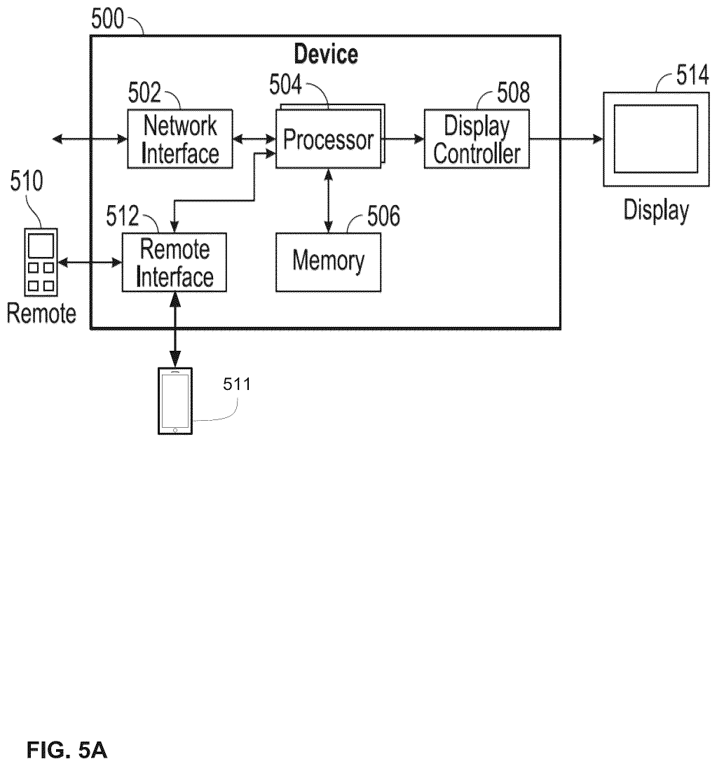

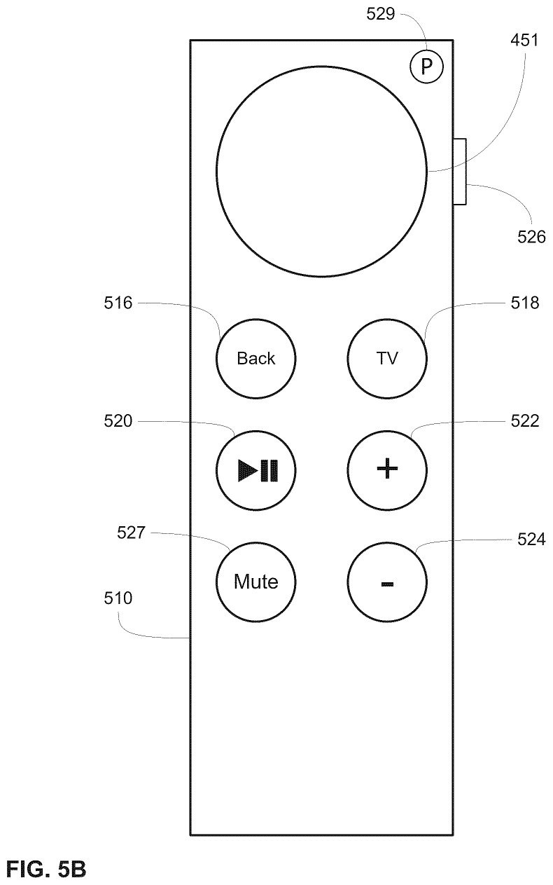

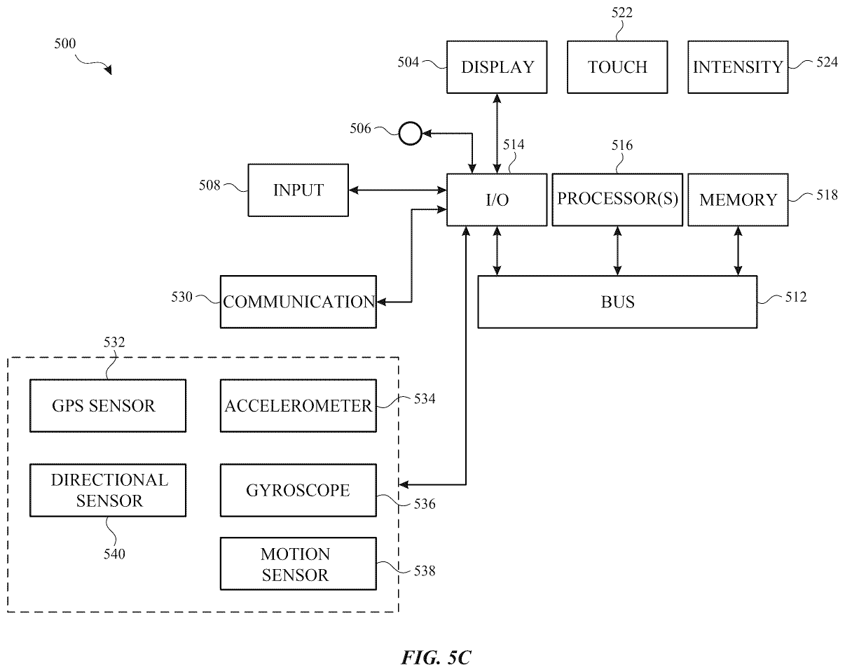

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700).

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4B; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524, 526, 527 and 529. Buttons 516, 518, 520, 522, 524, 526, 527 and 529 are optionally mechanical buttons or mechanical button alternatives that are able to sense contact with, or depression of, such buttons to initiate corresponding action(s) on, for example, device 500. In some embodiments, selection of “back” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “TV” button 518 by a user navigates device 500 to a main, home, media browsing user interface or root user interface from any user interface that is displayed on device 500 (e.g., to a home screen of device 500 that optionally includes one or more applications accessible on device 500 or to a media browsing user interface of device 500 that includes representations of media available for viewing via device 500). In some embodiments, selection of the “TV” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 (e.g., which is optionally a button on the side surface of remote 510, rather than on the surface of remote 510 that includes buttons 516, 518, 520, 522, 524 and 527) by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote. In some embodiments, selection of “Mute” button 527 toggles the audio reproduced by device 500 on and off. In some embodiments, selection of “Power” button 529 causes device 500 (and/or external devices coupled to device 500, such as display 514) to toggle between entering or exiting a low or off power state.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 7 and 9. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5C, but can include other or additional components in multiple configurations.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interface Specific to Respective Content Items” (Attorney Docket No.: 106843171900 (P42092USP1), filed Mar. 24, 2019), each of which is hereby incorporated by reference.

Attention is now directed towards embodiments of user interfaces (“UI”) and associated processes that are implemented on an electronic device, such as portable multifunction device 100, device 300, or device 500.

### USER INTERFACES AND ASSOCIATED PROCESSES

### Generating Algorithmic Content

Providing efficient ways of generating algorithmic content for a device enhances user interactions with the device by reducing the time and inputs needed to generate such content and reducing user errors-which further reduces the computing resources needed to generate and/or display the algorithmic content. In some embodiments, the algorithm for generating the algorithmic content includes detecting a first event for transitioning a generated algorithmic screensaver for an electronic device from a first scene to a second scene, different from the first scene. In some embodiments, the algorithm includes determining a first scene type of the first scene. In some embodiments, the algorithm includes determining a second scene type of the second scene. In some embodiments, the algorithm includes selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition. Enhancing the generation of algorithmic content reduces the amount of time needed by a user and/or the device to generate the algorithmic content, and thus reduces the power usage of the device and increases battery life for battery-powered devices. It is understood that people use devices. When a person uses a device, that person is optionally referred to as a user of the device.

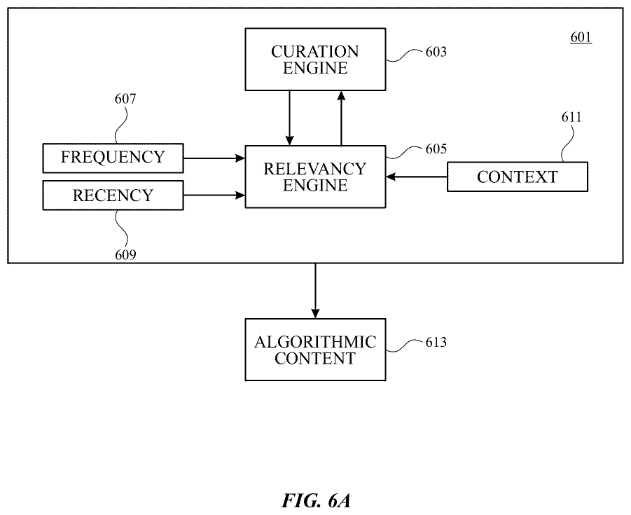

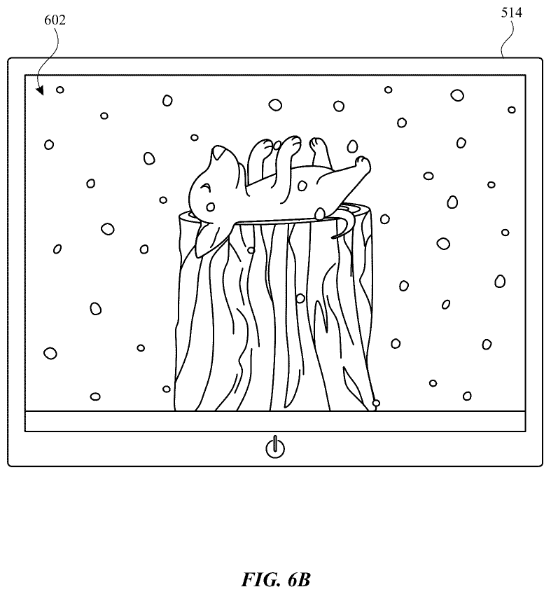

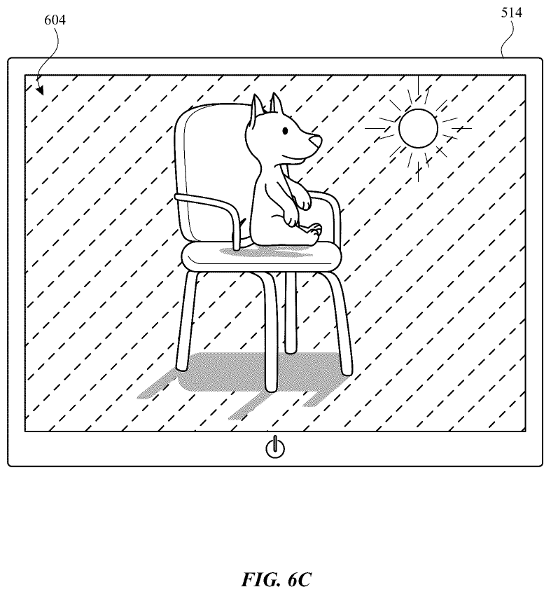

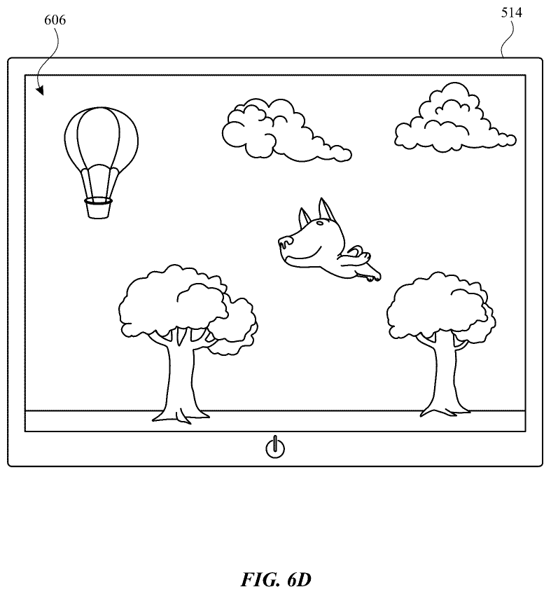

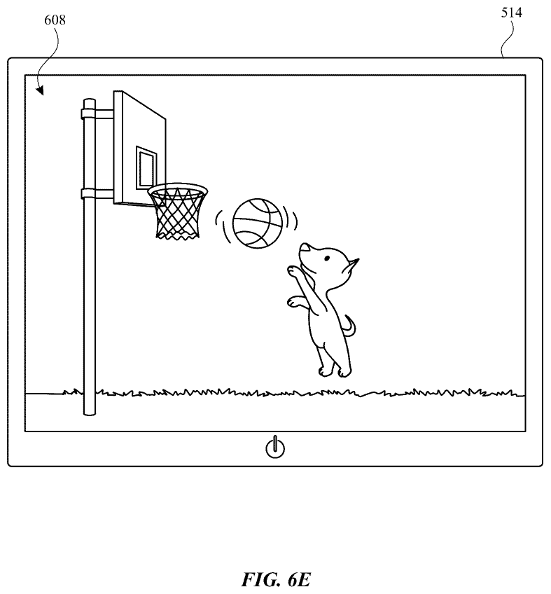

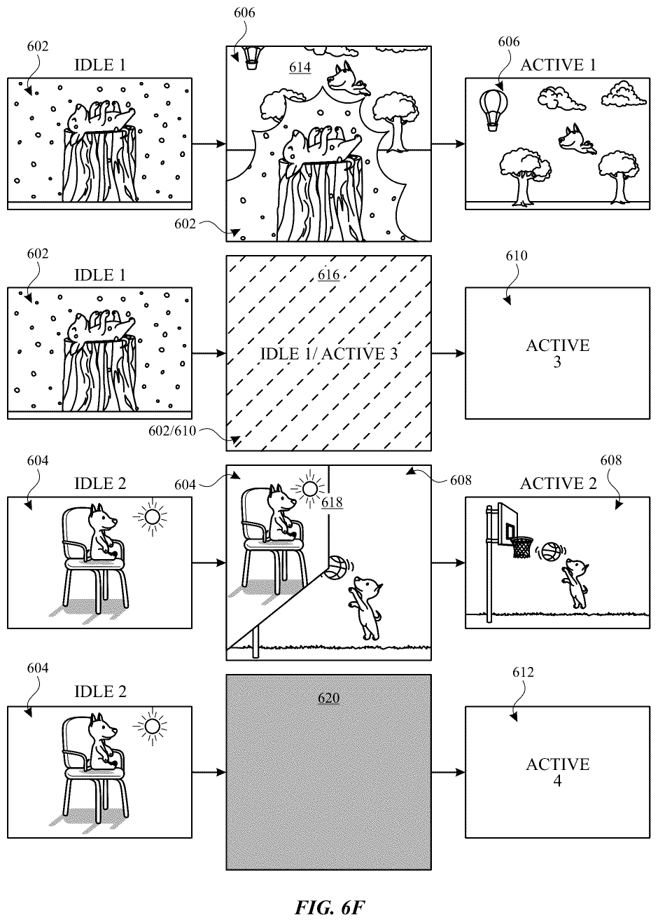

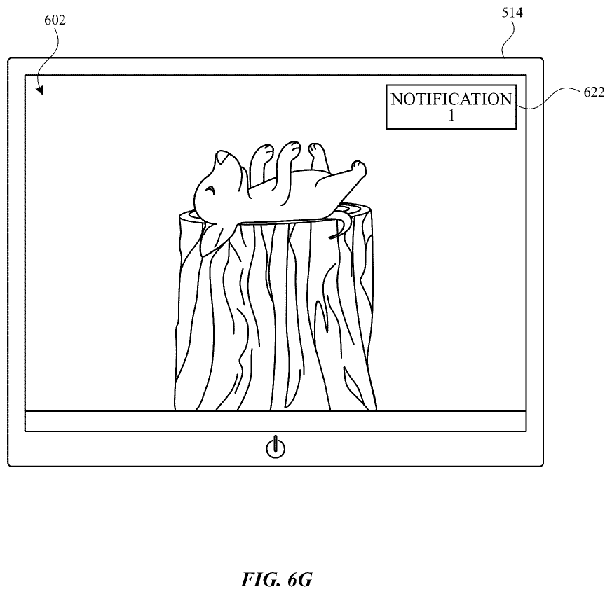

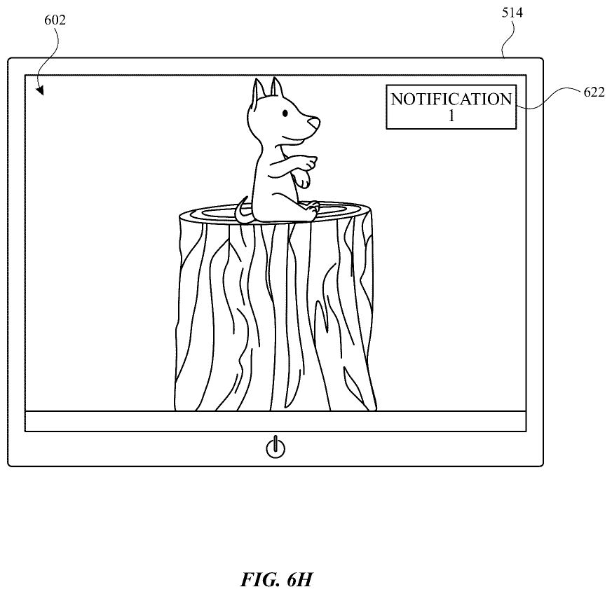

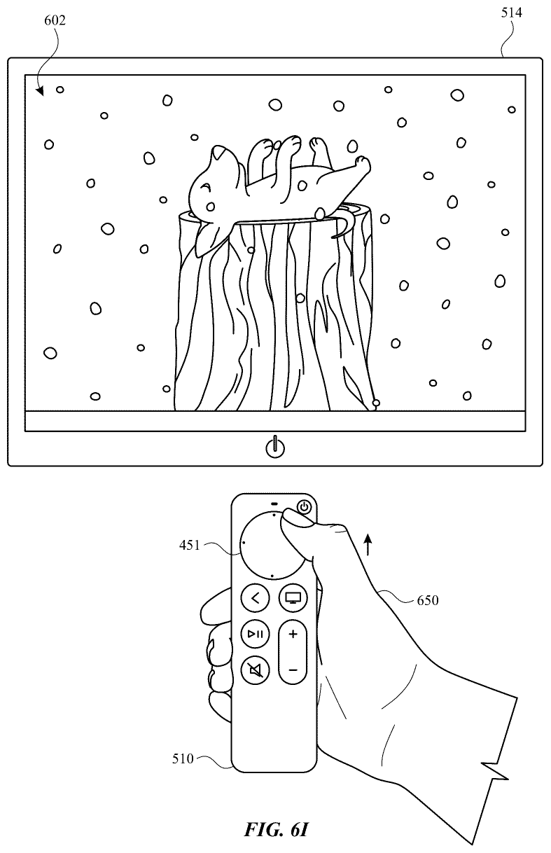

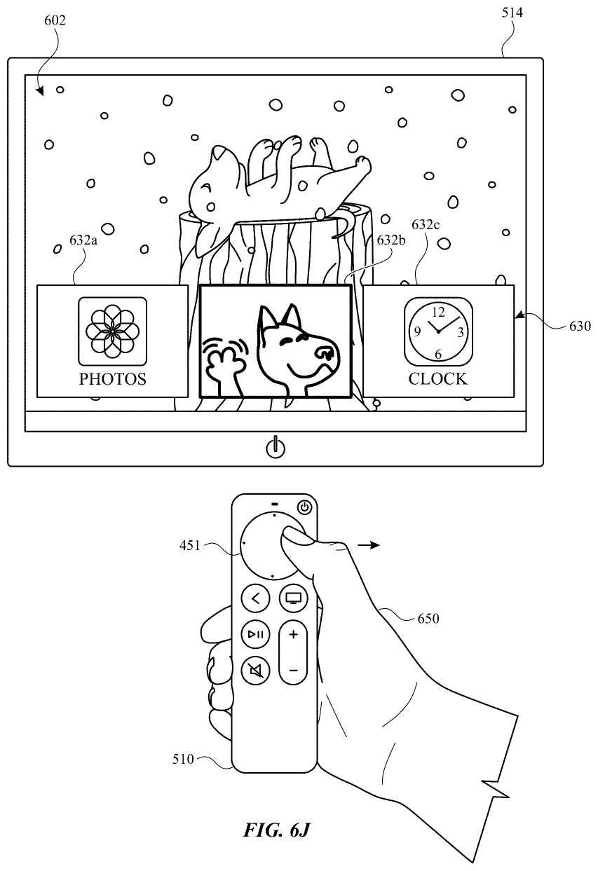

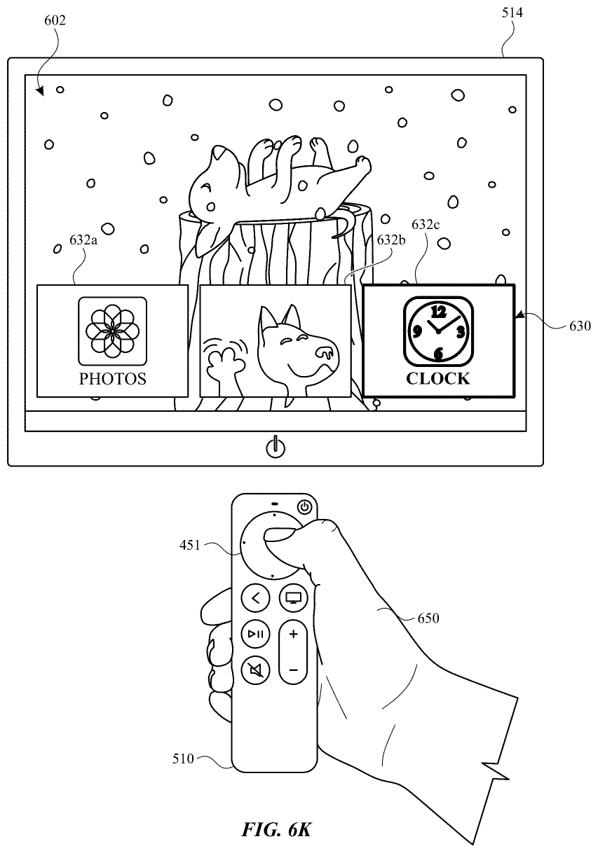

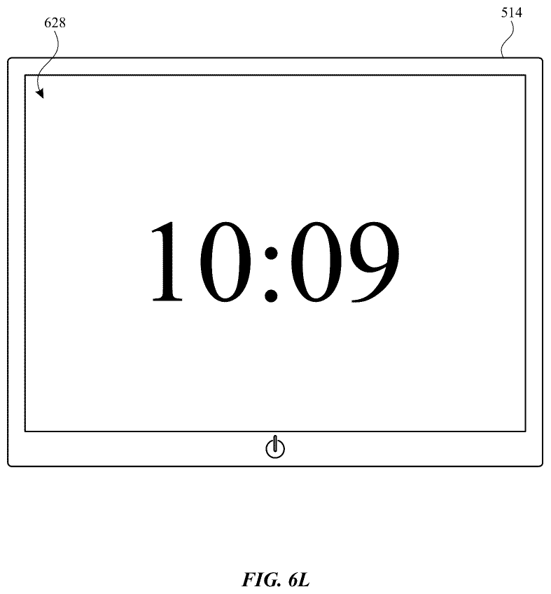

FIGS. 6A-6L illustrate exemplary ways in which an electronic device generates and/or displays an algorithmic screensaver (or other content) in accordance with some embodiments of the disclosure. The embodiments in these figures are used to illustrate the processes described below, including the processes described with reference to FIG. 7.

In some embodiments, the algorithmic screensaver (or other content) is generated using a generation engine 601, as shown in FIG. 6A. Generation engine 601 is optionally implemented by hardware and/or software of an electronic device, such as the hardware and/or software of devices 100, 300, and/or 500 described with reference to FIGS. 1-5. The algorithmic screensaver (or other content) is optionally displayed via a display generation component (e.g., 514).

An algorithmic screensaver is optionally a content item (e.g., video, sequence or images and/or animation) that is generated in real-time and/or near real-time (e.g., it is not pre-generated) for display on via a display generation component of an electronic device, optionally without the need for user input to specify the content of the algorithmic screensaver. In some embodiments, one or more components of the screensaver are pre-generated, and an automated and/or computer-performed algorithm is used to piece together (e.g., sequence) such components in real-time and/or near real-time. The algorithm is optionally implemented by the generation engine 601 in FIG. 6A. In some embodiments, the algorithm generates in real-time and/or near real-time the components of the screensaver as well as the piecing together (e.g., the sequencing) of the components of the screensaver. The algorithm is optionally implemented by the generation engine 601 in FIG. 6A. In some embodiments, the method described herein can additionally or alternatively be used to more generally generate a content item (e.g., video, sequence or images and/or animation) that is generated in real-time and/or near real-time, without the content item being required to be used as a screensaver. In some embodiments, the generation engine 601 outputs the algorithmic content 613 (e.g., the algorithmic screensaver).

Example algorithms implemented by the generation engine 601 are described further with reference to method 700. However, at a higher level, a curation engine 603 is communicatively coupled to a relevancy engine 605. The relevancy engine 605 optionally selects components for use in the algorithmic screensaver based on a number of factors, as well as based on information received from the curation engine 603. The curation engine 603 optionally composites together the various components selected by the relevancy engine 605 to generate the algorithmic screensaver 613. The curation engine 603 optionally supplies the relevancy engine 605 with high level requirements for the components to be selected by the relevancy engine 605 (e.g., indicating a required distribution of different types of components with respect to the total duration of the algorithmic screensaver and/or the how those components should be distributed in time through the duration of the algorithmic screensaver). The relevancy engine 605 optionally selects the most relevant components (as defined by the algorithm(s) implemented by the relevancy engine 605, such as described further with reference to method 700) for the algorithmic screensaver given the distribution requirements provided by the curation engine 603.

The relevancy engine 605 optionally selects such components based on a number of inputs, such as frequency information 607, recency information 609 and/or device context 611. Frequency information 607 optionally defines how frequently a given component has been used and/or selected for the algorithmic screensaver (optionally within a preceding time window including the current time, such as 1, 3, 5, 10, 30 or 60 minutes). Recency information 609 optionally defines how recently a given component has been used and/or selected for the algorithmic screensaver (optionally within a preceding time window including the current time, such as 1, 3, 5, 10, 30 or 60 minutes). Context information 611 is optionally information related to any aspect of the device that is generating and/or displaying the algorithmic screensaver, such as information about the user of the device, the location of the device (e.g., a geographic location of the device), and/or application data on the device (e.g., calendar data, content consumption data, etc.).

As described further with reference to method 700, relevancy engine 605 uses inputs such as frequency information 607, recency information 609 and/or device context 611 to select components for the algorithmic screensaver. The components for the algorithmic screensaver include components such as idle scenes, active scenes, transitions, and/or backgrounds. In some embodiments, idle scenes are generated by the algorithm (e.g., by generation engine 601) in real-time and/or near real-time (e.g., it is not pre-generated) by combining and/or compositing multiple animations together into a scene. For example, an idle scene optionally is a composite of one or more components such as a representation (e.g., image, animation or video) of a dog house or tree house, weather effects (e.g., representations or clouds, rain, sun, or the like), a representation of an animated character (e.g., image, animation or video), and/or representations of additional animated characters (e.g., image, animation or video). The relevancy engine 605 described herein optionally selects different components and their sequencing to generate the idle scene, as described in more detail herein.

In some embodiments, active scenes are pre-generated (e.g., not generated by the algorithm). In some embodiments, idle scenes have a first duration (e.g., 1, 3, 5, 20 or 30 minutes), and active scenes have a second duration (e.g., 0.5, 1, 3, or 5 minutes), different from and/or shorter or longer than the idle scenes. In some embodiments, the relevancy engine 605 determines the inclusion and/or sequencing of actives scenes in the screensaver as described herein. In some embodiments, the generation engine 601 alternates between idle scenes and active scenes in generating the screensaver.

In some embodiments, the relevancy engine 605 selects transitions between idle and active scenes of the algorithmic screensaver. As described in more detail with reference to method 700, a transition optionally describes a manner of switching from displaying one scene to displaying another scene, such as a cross-fade effect, a color dip effect, or a sprite mask effect. In some embodiments, the transition that is selected is selected by the relevancy engine 605 automatically (e.g., without user input).

In some embodiments, the relevancy engine 605 selects backgrounds for the idle scenes in the algorithmic screensaver. In some embodiments, the background pattern, color and/or appearance of idle scenes is independently controllable over the remaining aspects of the idle scenes (e.g., which are optionally displayed over the background). Thus, in some embodiments, the relevancy engine 605 selects a particular background for inclusion (or not) in the screensaver based on relevancy of that background to the context of the electronic device, as described in more detail with reference to method 700.

FIGS. 6B-6L illustrate example components of an algorithmic screensaver of this disclosure. FIG. 6B illustrates an example idle scene 602 of the algorithmic screensaver. Relevancy engine 605 has selected a snowy weather effect for idle scene 602, because the time of year at the device is winter time and/or weather data at the device indicates it is snowing. Relevancy engine 605 has also selected an animation component of the animated character for idle scene 602 that includes the animated character sleeping on a tree stump based on the relevancy factors described with reference to FIG. 6A and method 700.

FIG. 6C illustrates a different example idle scene 604 of the algorithmic screensaver. Relevancy engine 605 has selected a sunny weather effect and/or visual component (e.g., the sun) for idle scene 604, because the time of year at the device is summer time and/or the time of day at the device indicates it is sunny. Relevancy engine 605 has also selected an animation component of the animated character for idle scene 604 that includes the animated character sitting on a chair based on the relevancy factors described with reference to FIG. 6A and method 700. Finally, relevancy engine 605 has selected a background for idle scene 604 that has a particular color, pattern and/or other content based on the relevancy factors described with reference to FIG. 6A and method 700.

FIG. 6D illustrates an example active scene 606 of the algorithmic screensaver. Relevancy engine 605 has selected active scene 606 based on the relevancy factors described with reference to FIG. 6A and method 700, including based on the idle scene selected as preceding active scene 606 in the algorithmic screensaver and/or the transition selected for transitioning away from the idle scene selected as preceding active scene 606 (and thus into the active scene 606), as will be described in more detail with reference to FIG. 6F and method 700. In FIG. 6D, active scene 606 is one that includes the animated character of the algorithmic screensaver flying through the air.

FIG. 6E illustrates an example active scene 608 of the algorithmic screensaver. Relevancy engine 605 has selected active scene 608 based on the relevancy factors described with reference to FIG. 6A and method 700, including based on the idle scene selected as preceding active scene 608 in the algorithmic screensaver and/or the transition selected for transitioning away from the idle scene selected as preceding active scene 608 (and thus into the active scene 608), as will be described in more detail with reference to FIG. 6F and method 700. In FIG. 6E, active scene 608 is one that includes the animated character of the algorithmic screensaver playing basketball.

As described previously, relevancy engine 605 also selects transitions for transitioning between selected idle and active scenes in the algorithmic screensaver, and optionally does so based on the relevancy factors described with reference to FIG. 6A and method 700. Additionally, certain idle scenes optionally limit the transitions that can be selected to transition out of those idle scenes, and relevancy engine 605 selects the transitions according to such restrictions. Further, in some embodiments, certain active scenes limit the transitions that can be selected to transition into those active scenes, and relevancy engine 605 selects the transitions and/or the active scenes according to such restrictions. Additional details about the algorithm(s) used to select transitions and/or active scenes for the algorithmic screensaver are described with reference to method 700.

FIG. 6F illustrates some example transitions of the disclosure based on the above-described factors. For example, FIG. 6F illustrates transition 614 between idle scene 602 and active scene 606, transition 616 between idle scene 602 and active scene 610, transition 618 between idle scene 604 and active scene 608, and transition 620 between idle scene 604 and active scene 612. Focusing on transition 614 in FIG. 6F, relevancy engine 605 has selected transition 614 to transition out of idle scene 602, and into active scene 606. Idle scene 602 optionally limits the transitions out of idle scene 602 to be transitions that are visually or thematically compatible with occurring subsequent to a scene in which the animated character is sleeping, such as in idle scene 602. Thus, relevancy engine 605 has selected transition 614 (based on the relevancy factors described with reference to FIG. 6A and method 700, in addition to the restrictions specified by idle scene 602), which is optionally a sprite mask transition that emulates a dream-like transition from idle scene 602 to active scene 606 (e.g., such as an animated dream cloud taking over idle scene 602). Further, relevancy engine 605 has selected active scene 606 to transition into (based on the relevancy factors described with reference to FIG. 6A and method 700, in addition to the restrictions specified by idle scene 602, transition 614 and/or active scene 606), because idle scene 602, transition 614 and/or active scene 606 specify restrictions that ensure that active scene 606 is one that is visually or thematically compatible with occurring subsequent to a scene in which the animated character is sleeping, such as in idle scene 602, and subsequent to a dream-like transition, such as transition 614. For example, active scene 608 and/or active scene 612 are optionally not available to relevancy engine 605 for transitioning into from idle scene 602. Additional details about a sprite mask transition, such as transition 614, are provided with reference to method 700.

Focusing on transition 616 in FIG. 6F, relevancy engine 605 has selected transition 616 to transition out of idle scene 602, and into active scene 610. Idle scene 602 optionally limits the transitions out of idle scene 602 to be transitions that are visually or thematically compatible with occurring subsequent to a scene in which the animated character is sleeping, such as in idle scene 602. However, in FIG. 6F, transition 616 is optionally a crossfade transition that is compatible with any idle scene and/or any active scene. Thus, relevancy engine 605 has selected transition 616 (based on the relevancy factors described with reference to FIG. 6A and method 700) from idle scene 602 to active scene 610 (e.g., such as an effect where the idle scene 602 fades out while active scene 610 fades in). Further, relevancy engine 605 has selected active scene 610 to transition into (based on the relevancy factors described with reference to FIG. 6A and method 700, in addition to the restrictions specified by idle scene 602, transition 614 and/or active scene 610, if any), because idle scene 602, transition 614 and/or active scene 610 optionally specify restrictions that ensure that active scene 610 is one that is visually or thematically compatible with occurring subsequent to a scene in which the animated character is sleeping, such as in idle scene 602. If active scene 610 is one that is compatible with any idle scene and/or transition, then relevancy engine 605 selects active scene 610 based on the relevancy factors described with reference to FIG. 6A and method 700. Additional details about a crossfade transition, such as transition 616, are provided with reference to method 700.

Focusing on transition 618 in FIG. 6F, relevancy engine 605 has selected transition 618 to transition out of idle scene 604, and into active scene 608. Idle scene 604 optionally limits the transitions out of idle scene 604 to be transitions that are visually or thematically compatible with occurring subsequent to a scene in which the animated character is sitting awake on a chair, such as in idle scene 604. Thus, relevancy engine 605 has selected transition 618 (based on the relevancy factors described with reference to FIG. 6A and method 700, in addition to the restrictions specified by idle scene 604), which is optionally a sprite mask transition that emulates a passage-of-time transition from idle scene 604 to active scene 608 (e.g., such as an animated sweep of a clock arm taking over idle scene 604). Further, relevancy engine 605 has selected active scene 608 to transition into (based on the relevancy factors described with reference to FIG. 6A and method 700, in addition to the restrictions specified by idle scene 604, transition 618 and/or active scene 608, if any), because idle scene 604, transition 618 and/or active scene 608 optionally specify restrictions that ensure that active scene 608 is one that is visually or thematically compatible with occurring subsequent to a scene in which the animated character is sitting awake on a chair, such as in idle scene 604, and subsequent to a passage-of-time transition, such as transition 618. For example, active scene 606 and/or active scene 610 are optionally not available to relevancy engine 605 for transitioning into from idle scene 604. Additional details about a sprite mask transition, such as transition 618, are provided with reference to method 700.

Focusing on transition 616 in FIG. 6F, relevancy engine 605 has selected transition 620 to transition out of idle scene 604, and into active scene 612. Idle scene 604 optionally limits the transitions out of idle scene 604 to be transitions that are visually or thematically compatible with occurring subsequent to a scene in which the animated character is sitting awake on a chair, such as in idle scene 604. However, in FIG. 6F, transition 620 is optionally a color dip transition that is compatible with any idle scene and/or any active scene. Thus, relevancy engine 605 has selected transition 620 (based on the relevancy factors described with reference to FIG. 6A and method 700) from idle scene 604 to active scene 612 (e.g., such as an effect where the idle scene 604 transitions (e.g., fades) into a solid color, and then transitions (e.g., fades) into active scene 612). Further, relevancy engine 605 has selected active scene 612 to transition into (based on the relevancy factors described with reference to FIG. 6A and method 700, in addition to the restrictions specified by idle scene 604, transition 620 and/or active scene 612, if any), because idle scene 604, transition 620 and/or active scene 612 optionally specify restrictions that ensure that active scene 612 is one that is visually or thematically compatible with occurring subsequent to a scene in which the animated character is sitting awake on a chair, such as in idle scene 604. If active scene 612 is one that is compatible with any idle scene and/or transition, then relevancy engine 605 selects active scene 612 based on the relevancy factors described with reference to FIG. 6A and method 700. Additional details about a color dip transition, such as transition 620, are provided with reference to method 700.

In some embodiments, relevancy engine 605 selects components for the algorithmic screensaver based on events that occur at the device that is displaying the algorithmic screensaver via display 514. For example, in FIG. 6G, the relevancy engine 605 has selected idle scene 602 as the current scene for the algorithmic screensaver. During the presentation of idle scene, the device detects a notification event (e.g., an incoming message notification, an incoming phone call notification, or a smart home notification), and in response displays notification 622 corresponding to the event (e.g., including information about the notification event) overlaying idle scene 602. Relevancy engine 605 optionally also receives an indication of and/or information about the notification event at device 500, and in response to the notification event, relevancy engine 605 optionally (e.g., in real-time or near real-time) selects new components for idle scene 602 based on the relevancy factors described with reference to FIG. 6A and method 700 and based on the notification event. For example, relevancy engine 605 selects animation components for the animated character in idle scene 602 that include the animated character reacting to the notification. For example, in FIG. 6H, relevancy engine 605 has selected animation components for the animated character that include the animated character waking up, sitting up and/or pointing at the notification 622 displayed by the device. Additional details about how relevancy engine 605 selects components for the animated screensaver based on events and/or notifications at device 500 are described with reference to method 700.

In some embodiments, the device that is displaying the algorithmic screensaver via display 514 provides for the ability to manually switch between different screensavers, such as switching between the algorithmic screensaver and one or more other (optionally non-algorithmic) screensavers available on the device. For example, in FIG. 6I, while the device is displaying the algorithmic screensaver (e.g., while displaying idle scene 602), the device detects a directional swipe on touchpad 451 of remote control 510. The directional swipe is optionally in a first direction (e.g., an upward or downward swipe of a contact on touchpad 451). In response, as shown in FIG. 6J, the device displays a screensaver switching interface 630 that includes representations 632a, 632b and 632c of screensavers that are available for selection on the device. The representations 632a, 632b and 632c optionally include one or more images corresponding to (e.g., identifying) the different screensavers. In some embodiments, the representations 632a, 632b and 632c are overlaid on the screensaver that is currently being displayed by the device (e.g., idle scene 602 in FIG. 6J).

In FIG. 6J, screensaver switching interface 630 includes representation 632a, which corresponds to a Photos screensaver that includes sequentially displaying photos and/or videos from a photos library of the user of the device, representation 632b, which corresponds to the algorithmic screensaver of the disclosure, and representation 632c, which corresponds to a Clock screensaver that includes displaying a current time at the device. Additional representations of additional screensavers are optionally displayed in response to left/right swipes on touchpad 451 of remote 510. Further, the representations included in screensaver switching interface 630 are optionally selected to cause the device to switch to displaying the selected screensaver.

Representation 632b of the algorithmic screensaver is optionally animated (e.g., includes one or more animated components, analogous to the animated components of the algorithmic screensaver itself). In some embodiments, representations other than the representation 632b of the algorithmic screensaver are not animated; optionally, representations other than the representation 632b of the algorithmic screensaver are animated. Relevancy engine 605 optionally selects the components to include in representation 632b, optionally based on the relevancy factors described with reference to FIG. 6A and method 700 (e.g., based on the same relevancy factors used for selecting the components of the algorithmic screensaver itself). Therefore, the animation and/or content of representation 632b optionally has one or more of the characteristics of the animation and/or content of the algorithmic screensaver itself. In FIG. 6J, representation 632b includes the animated character of the algorithmic screensaver waving, as if waving at the viewer(s) of display 514.

As mentioned previously, screensaver switching interface 630 is optionally navigable in response to directional swipe inputs detected on touchpad 451 of remote 510 in a second direction, different from (e.g., orthogonal to) the first direction described with reference to FIG. 6I (e.g., the direction for displaying screensaver switching interface 630). For example, the second direction is optionally leftward or rightward swipes on touchpad 451 to navigate from one representation to another in screensaver switching interface 630 depending on the direction of the swipe. In FIG. 6J, representation 632b has the current focus (e.g., as indicated by the bolded outline of representation 632b). In FIG. 6J, the device detects a rightward swipe on touchpad 451. In response, as shown in FIG. 6K, the device displays the current focus moving away from representation 632b and to representation 632c. In FIG. 6K, the device detects a selection input on touchpad 451 (e.g., a click of touchpad 451). In response, because representation 632c had the current focus when the selection input was detected, the device ceases displaying the algorithmic screensaver via display 514, and instead displays the screensaver corresponding to representation 632c (e.g., the Clock screensaver 628) via display 514, as shown in FIG. 6L. If the device had instead detected selection of representation 632a, the device would have optionally ceased displaying the algorithmic screensaver via display 514, and instead displayed the screensaver corresponding to representation 632a (e.g., the Photos screensaver) via display 514.

It is understood that one or more or all inputs described above as being detected via remote 510 (e.g., via touchpad 451 or otherwise) can additionally or alternatively be detected via a remote control user interface of device 511, that optionally has analogous regions, controls and/or functionalities as the regions, controls and/or functionalities of remote 510.

FIG. 7 is a flow diagram illustrating a method of generating an algorithmic screensaver in accordance with some embodiments. The method 700 is optionally performed at an electronic device such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways to facilitate efficient generation of an algorithmic screensaver. For battery-operated electronic devices, increasing the efficiency of generating an algorithmic screensaver conserves power and increases the time between battery charges.

In some embodiments, method 700 is performed at an electronic device in communication with one or more display generation components and one or more input devices. For example, a mobile device (e.g., a tablet, a smartphone, a media player, a set-top box, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor). In some embodiments, the method is performed at a server in response to receiving, from a separate device (e.g., a mobile phone, a tablet computer, a set-top box, a smart watch, etc.) information for triggering generation of the transition of the generated algorithmic screensaver. In some embodiments, the method 700 is performed at the components illustrated in FIG. 6A.

In some embodiments, the method includes detecting (702a) a first event for transitioning a generated algorithmic screensaver for an electronic device from a first scene to a second scene, different from the first scene, such as an event for transitioning from scene 602 to scene 606.

In some embodiments, the first event is or corresponds to the ending of the first scene (e.g., reaching an end of playback of the first scene, reaching an end of a timer duration that defines the length of the first scene (e.g., 3 minutes, 5 minutes, 10 minutes, or 15 minutes), or reaching a point that is within a threshold (e.g., threshold time or threshold playback progression, such as with 10, 30 or 60 seconds of the end of the first scene, or such as within 1%, 3%, 10% or 20% of the total playback progression) of the end of the first scene. In some embodiments, the first event includes user input. In some embodiments, the first event does not include or correspond to user input. In some embodiments, some or all aspects of the method and/or algorithm described herein are performed automatically, without user input.

An algorithmic screensaver is optionally a content item (e.g., video, sequence or images and/or animation) that is generated in real-time and/or near real-time (e.g., it is not pre-generated) for display on via a display generation component of an electronic device. In some embodiments, one or more components of the screensaver are pre-generated, and an automated and/or computer-performed algorithm is used to piece together (e.g., sequence) such components in real-time and/or near real-time. In some embodiments, the algorithm generates in real-time and/or near real-time the components of the screensaver as well as the piecing together (e.g., the sequencing) of the components of the screensaver. In some embodiments, the method described herein can additionally or alternatively be used to more generally generate a content item (e.g., video, sequence or images and/or animation) that is generated in real-time and/or near real-time, without the content item being required to be used as a screensaver.

In some embodiments, the first scene and the second scene are content items (e.g., video, sequence or images and/or animation) that are generated in real-time and/or near real-time (e.g., it is not pre-generated) by the algorithm as different portions of the screensaver in the ways described herein. In some embodiments, the algorithm first generates and/or displays the first scene, and after generating/displaying the first scene, generates and/or displays the second scene. In some embodiments, the second scene is selected and/or generated by the algorithm to immediately follow the first scene in the screensaver, with a transition sequence that is generated and/or displayed in between the two scenes, as will be described in more detail later.

In some embodiments, the method includes determining (702b) a first scene type of the first scene, such as the type of scene 602.

In some embodiments, the algorithm categorizes different scenes into different types of scenes. In some embodiments, the types of available scenes for the screensaver are idle scenes and active scenes. In some embodiments, scenes are tagged with metadata that defines whether the scene is an idle scene or an active scene, and the algorithm checks that metadata tag to make the determination of scene type. In some embodiments, idle scenes are generated by the algorithm in real-time and/or near real-time (e.g., it is not pre-generated) by combining and/or compositing multiple animations together into a scene. For example, an idle scene optionally is a composite of one or more components such as a representation (e.g., image, animation or video) of a dog house, weather effects (e.g., representations or clouds, rain, sun, or the like), a representation of an animated character (e.g., image, animation or video), and/or representations of additional animated characters (e.g., image, animation or video). The algorithm/method described herein optionally selects different components and their sequencing to generate the idle scene, as described in more detail herein.

In some embodiments, active scenes are pre-generated (e.g., not generated by the algorithm). In some embodiments, idle scenes have a first duration (e.g., 1, 3, 5, 20 or 30 minutes), and active scenes have a second duration (e.g., 0.5, 1, 3, or 5 minutes), different from and/or shorter or longer than the idle scenes. In some embodiments, the algorithm selects the inclusion and/or sequencing of actives scenes in the screensaver as described herein. In some embodiments, the algorithm alternates between idle scenes and active scenes in generating the screensaver.

In some embodiments, the method includes determining (702c) a second scene type of the second scene (e.g., as described above), such as the type of scene 606.

In some embodiments, the method includes (optionally in response to detecting the first event) selecting (702d) a first transition sequence (e.g., an animated transition sequence) for transitioning the algorithmic screensaver from the first scene to the second scene based on the determined first scene type and the determined second scene type, such as one of transitions 614, 616, 618 or 620, wherein the first transition sequence defines a visual effect applied to at least a portion of the first scene and at least a portion of the second scene during the transition, such as the visual effects described with reference to transitions 614, 616, 618 or 620. For example, the transition sequence, as described in more detail below, describes a manner of switching from displaying the first scene to displaying the second scene, such as a cross-fade effect, a color dip effect, or a sprite mask effect. In some embodiments, which transition sequence that is selected automatically by the algorithm (e.g., without user input) for transitioning between the first scene and the second scene is based on what the first scene is, what the second scene is, what category or type of scene the first scene is and/or what category or type of scene the second scene is. For example, the algorithm optionally, as implemented by the electronic device, optionally selects a different transition sequence for transitioning between the first scene and the second scene for different combinations of what the first scene is, what the second scene is, what category or type of scene the first scene is and/or what category or type of scene the second scene is. In some embodiments, the transition sequence does not alter the content of the first scene or the second scene, but rather is as after-effect that is applied to the display of the first scene and/or the display of the second scene to facilitate the transition (e.g., fading out the end of the first scene, and fading in the beginning of the second scene). Selecting a transition sequence for transitioning between scenes in an algorithmic screensaver that is based on the type of scenes that are being transitioned between ensures consistent and appropriate presentation of multiple scenes in the screensaver, and reduces computing resources needed to algorithmically select a transition (e.g., as compared to an instance where transitions were not associated with types of scenes, and the algorithm is required to consider and/or process a broader range of transitions from which to select).

In some embodiments, the visual effect is one or more of a sprite mask effect, a color dip effect or a crossfade effect, such as the visual effects described with reference to transitions 614, 616, 618 or 620. In some embodiments, the sprite mask effect is a static or animated mask that is applied to the first scene to cease display of one or more portions of the first scene as one or more portions of the second scene come into display. For example, the sprite mask is optionally a movie file that contains clear pixels and colored pixels. In some embodiments, the sprite mask starts with every pixel being clear, and animates in the colored pixels. The scene being transitioned into is optionally rendered over/on top of the scene being transitioned out of, with the scene being transitioned into being multiplied by the sprite mask. Thus, in some embodiments, the sprite mask defines which and when portions of the first scene cease to be displayed during the transition, and which and when portions of the second scene begin to be displayed during the transition. In some embodiments, the color dip effect is an animated transition that starts with the first scene being fully displayed, then fading in of a color on top of the first scene until the first scene is no longer visible and only the color being visible, followed by the first scene that is under the color being replaced by the second scene, and then fading out of the color on top of the second scene until the second scene is fully visible. In some embodiments, the crossfade effect is one in which the first scene is gradually ceased to be displayed, and the second scene is gradually displayed (optionally sequentially or concurrently). Utilizing one of the above-mentioned transition effects ensures that context during the transition is not lost, thereby reducing errors in interaction with the computer system and enhancing user experience.

In some embodiments, the first scene is associated with metadata that defines a first set of one or more permitted transition sequences for transitioning away from the first scene, such as permitted transition sequences away from scenes 602 or 604, the second scene is associated with metadata that defines a second set of one or more permitted transition sequences for transitioning into the second scene, such as permitted transition sequences into scenes 606, 608, 610 or 612, and selecting the first transition sequences includes selecting the first transition sequence from an intersection of the first set and the second set. In some embodiments, the first scene only permits a certain set of transitions for transitioning away from the first scene (and does not allow other available transitions for transitioning away from the first scene), and the second scene only permits a certain set of transitions for transitioning to the second scene (and does not allow other available transitions for transitioning to the second scene). The electronic device optionally, therefore, selects a transition that is permitted by both the first scene and the second scene for the transition. Selecting a transition sequence for transitioning between scenes in an algorithmic screensaver that is based on the permitted transitions of the scenes that are being transitioned-between ensures consistent and appropriate presentation of multiple scenes in the screensaver, and reduces computing resources needed to algorithmically select a transition.

In some embodiments, selecting the first transition sequence includes selecting the first transition based on a prior frequency of selection of the first transition sequence for use in the generated algorithmic screensaver. In some embodiments, the electronic device weights transitions based on how frequently the transitions have been selected previously (optionally during a certain window of time prior to the current time, such as within the last 10 minutes, 1 hour, 4 hours or 24 hours). In some embodiments, after such window of time, a given transition is treated as if it hasn't yet been selected as a transition. In some embodiments, the more frequently a transition has been selected previously, the less likely it is for the electronic device to select that transition now for the transition between the first and second scenes. In some embodiments, the electronic device, after weighting the various transitions as described, randomly or pseudo randomly selects a transition in accordance with the weightings. Selecting a transition sequence for transitioning between scenes in an algorithmic screensaver that is based on prior frequency of selection of the transition sequence ensures that the same transitions are not overly selected over time without the need for user input, and thus reduces computing resources needed to select a transition.

In some embodiments, selecting the first transition sequence includes selecting the first transition based on a recency of prior selection of the first transition sequence for use in the generated algorithmic screensaver. In some embodiments, the electronic device weights transitions based on how recently the transitions have been selected previously (optionally during a certain window of time prior to the current time, such as within the last 10 minutes, 1 hour, 4 hours or 24 hours). In some embodiments, after such window of time, a given transition is treated as if it hasn't yet been selected as a transition. In some embodiments, the more recently a transition has been selected previously, the less likely it is for the electronic device to select that transition now for the transition between the first and second scenes. In some embodiments, the electronic device, after weighting the various transitions as described, randomly or pseudo randomly selects a transition in accordance with the weightings. Selecting a transition sequence for transitioning between scenes in an algorithmic screensaver that is based on prior recency of selection of the transition sequence ensures that the same transitions are not overly selected over time without the need for user input, and thus reduces computing resources needed to select a transition.

In some embodiments, the metadata associated with the first scene indicates one or more first categories of permitted transition sequences for transitioning away from the first scene, the first set of one or more permitted transition sequences are part of a category of the one or more first categories, the metadata associated with the second scene indicates one or more second categories of permitted transition sequences for transitioning into the second scene, and the second set of one or more permitted transition sequences are part of a category of the one or more second categories. In some embodiments, additionally or alternatively to the first scene and/or the second scene indicating which individual transitions are permitted for those scenes, the first and/or second scenes indicate categories of transitions that are permitted for those scenes. When a scene indicates a particular category of transitions is permitted for that scene, the individual transitions in that category are optionally then considered permitted for that scene. Selecting a transition sequence for transitioning between scenes in an algorithmic screensaver that is based on permitted categories of the scenes that are being transitioned-between ensures consistent and appropriate presentation of multiple scenes in the screensaver, and reduces computing resources needed to indicate permitted transitions and algorithmically select a transition.

In some embodiments, the method includes after presenting the first transition sequence for transitioning the algorithmic screensaver from the first scene to the second scene, presenting the second scene (and/or initiating presentation of the second scene), such as scene 606, including in accordance with a determination that the first transition sequence has a first value for a first transition property, such as a dreamlike transition in transition 614 (e.g., the first transition sequence is a transition sequence that indicates the character in the screensaver is transitioning into a dream state, because the character has fallen asleep, such as the transition sequence being in the form of an animated dream balloon transition), presenting the second scene with a first value for a first scene property, such as the dreamlike content of scene 606. For example, the second scene is or includes content that is dream-like content, such as content that is unlikely to be real. For example, the second scene includes content like the character flying through the clouds, or having superhuman strength, or the like. The first value for the first transition property optionally corresponds to any aspect of the first transition sequence (e.g., the transition that is selected, particular content in the transition that is selected, how the transition is animated, etc.), and the first value for the first scene property optionally corresponds to any aspect of the second scene (e.g., the scene that is selected, particular content in the scene that is selected, how a character in the second scene is animated and/or placed, etc.).

In some embodiments, the method includes after presenting the first transition sequence for transitioning the algorithmic screensaver from the first scene to the second scene, presenting the second scene (and/or initiating presentation of the second scene), including in accordance with a determination that the first transition sequence has a second value for the first transition property, such as the time-passage transition in transition 618 (e.g., the first transition sequence is a transition sequence that indicates the character in the screensaver is transitioning from dreaming into being away, because the character has awoken, or is a transition sequence that indicates the character in the screensaver is transitioning from resting to engaging in an activity such as playing basketball), different from the first value for the first transition property, presenting the second scene with a second value for the first scene property, different from the first value for the first scene property, such as the content of scene 608, which makes sense to occur after time has passed since scene 604. For example, the second scene is or includes content that is back to reality or content that corresponds to the selected transition. For example, the second scene includes content like the character being back in back or back in a hammock, or the character getting up from such bed or hammock. In the case of the transition sequence being one that indicates the character is transitioning into engaging in an activity, the second scene optionally includes the character engaging in that activity. The second value for the first transition property optionally corresponds to any aspect of the first transition sequence (e.g., the transition that is selected, particular content in the transition that is selected, how the transition is animated, etc.), and the second value for the first scene property optionally corresponds to any aspect of the second scene (e.g., the scene that is selected, particular content in the scene that is selected, how a character in the second scene is animated and/or placed, etc.). Thus, in some embodiments, the transition that is selected optionally has an effect on the second scene that is selected and/or the content of the second scene that is selected. Selecting an aspect of the incoming scene in an algorithmic screensaver that is based on the transition selected for transitioning into that incoming scene ensures consistent and appropriate presentation of multiple scenes in the screensaver, without the need for user input, and thus reduces computing resources needed to generate the algorithmic screensaver.

In some embodiments, the method includes after presenting the second scene, such as scenes 606, 608, 610 or 612, and a second transition sequence for transitioning from the second scene to a third scene, such as transitions analogous or the same as transitions 614, 616, 618 or 620 (the second transition sequence optionally has one or more of the characteristics of the first transition sequence, including how it is selected; further, the third scene optionally has one or more of the characteristics of the first scene and/or the second scene, including how it is selected), wherein the third scene is of a same scene type as the first scene, such as idle scenes 602 and 604 (e.g., the third scene and the first scene are both idle scenes as described herein, or are both active scenes as described herein), presenting the third scene (and/or initiating presentation of the third scene), including in accordance with a determination that the first transition sequence has a first value for a first transition property (e.g., as described above), presenting the third scene with a first value for a first scene property (e.g., analogous to as described above with respect to the second scene), and in accordance with a determination that the first transition sequence has a second value for the first transition property (e.g., as described above), different from the first value for the first transition property, presenting the third scene with a second value for the first scene property, different from the first value for the first scene property (e.g., analogous to as described above with respect to the second scene). Thus, in some embodiments, the first scene transition that is selected optionally has an effect on the third scene that is selected and/or the content of the third scene that is selected, analogous to as described above with reference to the effect of the first transition sequence on the second scene that is selected and/or the content of the second scene that is selected. For example, if the first transition sequence is a dream-entering sequence, then the third scene that is returned-to after the second scene is optionally selected such that the character is still in the bed and/or hammock in which they fell asleep, whereas if the first transition sequence is a transition sequence that indicates the character is starting another activity like playing basketball, then the third scene that is returned-to after the second scene is optionally not limited to being one in which the character is at the same location/performing the same activity they were performing at the end of the first scene. Selecting an aspect of a future scene in an algorithmic screensaver that is based on the transition selected for transitioning into a prior scene ensures consistent and appropriate presentation of multiple scenes in the screensaver, without the need for user input, and thus reduces computing resources needed to generate the algorithmic screensaver.

In some embodiments, the first scene and the second scene have scene types selected from: an idle scene type, or an active scene type, such as described with reference to scenes 602, 604, 606, 608, 610 and 612. In some embodiments, the first scene is an active scene or an idle scene. In some embodiments, the second scene is an active scene or an idle scene. In some embodiments, the first scene and the second scene have different scene types (e.g., if one is an idle scene, the other is an active scene). In some embodiments, an active scene has a duration of approximately 1-2 minutes, and is presented approximately once every 10 minutes during the algorithmic screensaver. In some embodiments, an active scene is a pre-generated animated scene (e.g., its components are not selected in real-time or near real-time during generation of the algorithmic screensaver, such as described herein with reference to idle scenes). In some embodiments, the idle scene is generated in real-time or near real-time during generation of the algorithmic screensaver. For example, the components of the idle scene are selected and/or generated in the various ways described herein. In some embodiments, an idle scene is a composite of multiple animations (e.g., of one or more characters, or one or more weather effects, of one or more scenery elements, and the like). In some embodiments, the duration of an idle scene is longer than that of an active scene (e.g., 10 minutes in length). In some embodiments, the components of the idle scene are selected using the various selection criteria and/or logic described herein. Generating an algorithmic screensaver with a mix of active scenes and idle scenes ensures sufficient variety while also conserving computing resources (e.g., due to not requiring active generation of active scenes), without the need for user input, and thus reduces computing resources needed to generate the algorithmic screensaver.

In some embodiments, the method includes while presenting (e.g., displaying) the first scene of the generated algorithmic screensaver, wherein the first scene includes a first animated character that is presented with a first animation sequence, such as in scene 602 in FIG. 6G (e.g., for example, the first animated character is an animated human, animal, automobile, or the like, and the first animated character is stationary or is being animated performing a certain activity, such as driving, sitting, sleeping, or reading), detecting a second event at the electronic device, such as the occurrence of notification 622 in FIG. 6G (e.g., a user input, a notification, reaching a certain time of day, or any other event that can be detected at the electronic device).

In some embodiments, the method includes in response to detecting the second event, presenting the first animation character in the first scene with a second animation sequence, different from the first animation sequence, such as in scene 602 in FIG. 6H (e.g., for example, changing the animated character from being stationary to being active, or changing the activity being performed by the animated character). In some embodiments, if the second event had not occurred/been detected, the first animated character would continue to be presented with the first animation sequence, and the second animation sequence would not be presented. In some embodiments, the second animation sequence is an animation sequence of the animated character bringing attention to the event, such as pointing at a notification corresponding to the event, jumping up and down to grab the user's attention, or changing their behavior to match the content of the event (e.g., different behavior for different types of events, such as changing to reading an email on a laptop in response to an incoming email notification, or changing to cheering on a sports team in response to an upcoming sports game notification). In some embodiments, in response to detecting the event, the electronic device also displays a visual indication of the event (e.g., a notification with content corresponding to the substance of the event). Triggering the animated character to change animation sequences based on events detected at the electronic device ensures the animated character responds to events and provides visual feedback to a user of the events, thereby facilitating user/device interaction and reducing errors in such interaction.

In some embodiments, the second event is a notification event at the electronic device, such as described with reference to notification 622 in FIG. 6G. For example, the second event is a text message received at the electronic device, a notification of an incoming voice or video call at the electronic device, a notification of an upcoming content item (e.g., an upcoming sports game) accessible via the electronic device, or a notification of a breaking news item at the electronic device. Triggering the animated character to change animation sequences based on notifications detected at the electronic device ensures the animated character responds to notifications and provides visual feedback to a user of the notification, thereby facilitating user/device interaction and reducing errors in such interaction.

In some embodiments, the second event is a smart home event at the electronic device, such as described with reference to notification 622 in FIG. 6G. For example, the electronic device is optionally part of a smart or connected home setup or network, and the second even is a doorbell ring detected by the smart home, a status alert about a smart appliance in the home, a motion alert from a motion detector in the home, or an alert about a fire or smoke alarm status. Triggering the animated character to change animation sequences based on smart home events detected at the electronic device ensures the animated character responds to smart home events and provides visual feedback to a user of the smart home event, thereby facilitating user/device interaction and reducing errors in such interaction.

In some embodiments, the second event is detection of a person at the electronic device, such as if a person is detected as present at device 500, 510, 511 and/or 514. For example, the electronic device uses one or more sensors (e.g., cameras) or other circuitry (e.g., communication circuitry, such as Bluetooth or Wi-Fi) to detect that a person is present at the electronic device (e.g., within 1, 3, 5, 10, 30 or 50 feet of the electronic device). In response, the electronic device optionally displays a notification indicating the presence of the person (e.g., the notification indicates the identity of the person, the presence of the person, etc.). In some embodiments, in response to detecting the presence of the person, the animated character changes animation sequence (e.g., to wave or look at the person through the display). Triggering the animated character to change animation sequences based on presence detection at the electronic device ensures the animated character responds to presence and provides visual feedback to a user of the presence, thereby facilitating user/device interaction and reducing errors in such interaction.

In some embodiments, the method includes selecting one or more components for inclusion in the generated algorithmic screensaver based on relevancy to a context of the electronic device. In some embodiments, relevancy of a component of the screensaver is determined as described below. In some embodiments, the context of the electronic device is as described below. In some embodiments, the more relevant a component is determined to be, the more likely it is the component is selected for inclusion in screensaver, and the less relevant the component is determined to be, the less likely it is the component is selected for inclusion in the screensaver. In some embodiments, the relevancy of a particular component is determined by a relevancy engine in the software performing method 700. In some embodiments, the relevancy of the one or more components is determined without user input. Including components in the screensaver based on relevance ensures consistent and appropriate presentation of components of the screensaver, without the need for user input, and reduces computing resources needed to algorithmically generate the screensaver.

In some embodiments, the context of the electronic device is based on one or more of: calendar data at the electronic device (e.g., what events are scheduled today, at what times are the events scheduled, what events are scheduled for the current time at the electronic device, whether the current day and/or time of year is a holiday or holiday season (e.g., Thanksgiving day or season, or Christmas day or season) and/or what events are scheduled for the rest of the week), weather data at the electronic device (e.g., what is the current or future weather at the location of the electronic device, such as whether it is raining, snowing, cold, warm, sunny or cloudy), content consumption data at the electronic device (e.g., what movies, television shows and/or music has been consumed by a user of the electronic device today or in the last week), or time of day at the electronic device (e.g., whether it is morning, mid-day, afternoon or evening; whether it is sunrise; whether it is sunset; whether it is between sunrise and noon; and/or whether it is between 5 μm and sunset). In some embodiments, different components are selected depending on one or more of the above factors, as described herein. For example, if it is raining outside at the electronic device (e.g., determined from weather data from a weather server at the location of the electronic device), the components of the idle scene are optionally selected to correspond to a rainy scene (e.g., the idle scene includes animated rain, or the animated character is wearing a rain coat), whereas if the time of year is December, the components of the idle scene are optionally selected to correspond to a snowy scene (e.g., the idle scene includes animated snow, or the animated character is wearing snow clothes). Including components in the screensaver based on relevance to one or more context signals of the electronic device ensures consistent and appropriate presentation of components of the screensaver, without the need for user input, and reduces computing resources needed to algorithmically generate the screensaver.

In some embodiments, the relevancy of the one or more components is based on a prior frequency of selection of the one or more components for use in the generated algorithmic screensaver (e.g., such as described previously with reference to prior frequency of selection of the first transition sequence), and/or a recency of prior selection of the one or more components for use in the generated algorithmic screensaver (e.g., such as described previously with reference to prior recency of selection of the first transition sequence). Thus, in some embodiments, a given component is more likely to be selected if its prior frequency of selection is lower and/or its prior recency of selection is further in the past, and is less likely to be selection if its prior frequency of selection is higher and/or its prior recency of selection is less in the past. Selecting one or more components in an algorithmic screensaver based on prior frequency and/or recency of selection of the one or more components ensures that the same components are not overly selected over time without the need for user input, and thus reduces computing resources needed to select a component.

In some embodiments, in accordance with a determination that a respective component of the one or more components is a category of components (e.g., a category of components, analogous to a category of transitions previously described), a prior frequency of selection of the respective component for use in the generated algorithmic screensaver, and/or a recency of prior selection of the respective component for use in the generated algorithmic screensaver affect a relevancy of the respective component in a first manner, and in accordance with a determination that the respective component of the one or more components is not a category of components (e.g., a particular component rather than a category of components), the prior frequency of selection of the respective component for use in the generated algorithmic screensaver, and/or the recency of prior selection of the respective component for use in the generated algorithmic screensaver affect the relevancy of the respective component in a second manner, different from the first manner. In some embodiments, the prior frequency of selection of a respective category of components for use in the generated algorithmic screensaver, and/or the recency of prior selection of the respective category of components for use in the generated algorithmic screensaver will affect the likelihood of selection less than the prior frequency of selection of a respective component for use in the generated algorithmic screensaver, and/or a recency of prior selection of the respective component for use in the generated algorithmic screensaver. For example, while components included in a particular category will be somewhat reduced in likelihood for inclusion in the screensaver when another component included in that category is selected (e.g., based on frequency and/or recency), such reduced likelihood will optionally be less of a reduction than the reduced likelihood that a particular component will be selected for inclusion in the screensaver (e.g., based on frequency and/or recency). Example categories of components include components related to snow/winter/Christmas, components related to rain, components related to sunny weather, components related to sunrise, and components related to sunset. In some embodiments, the categories of components correspond to the various factors related to the context of the electronic device. Treating frequency and/or recency of selection differently for particular components as compared with categories of components ensures that particular components are not overly selected over time without the need for user input, while still allowing for other components in a particular category to be selected, and thus reduces computing resources needed to select a component.

In some embodiments, the one or more components include one or more idle scenes (e.g., idle scenes, as discussed above) for inclusion in the generated algorithmic screensaver, such as idle scenes 602 and/or 604. Thus, in some embodiments, the electronic device selects a particular idle scene for inclusion (or not) in the screensaver based on relevancy of that idle scene to the context of the electronic device, as described herein. Selecting idle scenes in the screensaver based on relevance ensures consistent and appropriate presentation of idle scenes of the screensaver, without the need for user input, and reduces computing resources needed to algorithmically generate the screensaver.

In some embodiments, the one or more components include one or more components of one or more idle scenes for inclusion in the generated algorithmic screensaver, such as the components included in idle scenes 602 and/or 604. Thus, in some embodiments, the electronic device selects particular components of idles scenes for inclusion (or not) in the screensaver based on relevancy of those components to the context of the electronic device, as described herein. In some embodiments, as described previously, the components of the idle scene(s) include: which animated character(s) to include, what weather effect(s) to include, what action(s) of the character(s) to include, and the like. Selecting components of idle scenes in the screensaver based on relevance ensures consistent and appropriate presentation of the components of the idle scenes of the screensaver, without the need for user input, and reduces computing resources needed to algorithmically generate the screensaver.

In some embodiments, the one or more components of one or more idle scenes include one or more components that can be included in any idle scene of the generated algorithmic screensaver (e.g., generic components, as described below), and one or more components that can be included in a first subset of idle scenes of the generated algorithmic screensaver but cannot be included in a second subset of idle scenes of the generated algorithmic screensaver. In some embodiments, idle scenes are associated with respective metadata that defines what components are permitted for use in the idle scenes, and optionally what components are not permitted for use in the idle scenes (e.g., analogous to the permitted transition sequences for idle scenes, described previously). In some embodiments, different idle scenes define different (and/or independent) sets of permitted and/or unpermitted components for use in those idle scenes. In some embodiments, a given component is associated with metadata that indicates whether that component is a generic component (e.g., can be used in any idle scene) or whether that component is limited for use with particular idle scene(s). For example, an idle scene that is associated with a sleeping animated character optionally cannot include components that are incompatible with sleeping (e.g., animation of the character playing basketball); however, any idle scene can optionally include particular weather effects. Selecting components for idle scenes in an algorithmic screensaver based on permitted components for the idle scenes ensures consistent and appropriate presentation of multiple scenes in the screensaver, and reduces computing resources needed to algorithmically select such components.

In some embodiments, the one or more components include one or more active scenes (e.g., active scenes, as discussed above) for inclusion in the generated algorithmic screensaver, such as active scenes 606, 608, 610 and/or 612. Thus, in some embodiments, the electronic device selects a particular active scene for inclusion (or not) in the screensaver based on relevancy of that active scene to the context of the electronic device, as described herein. Selecting active scenes in the screensaver based on relevance ensures consistent and appropriate presentation of active scenes of the screensaver, without the need for user input, and reduces computing resources needed to algorithmically generate the screensaver.

In some embodiments, the one or more components include one or more backgrounds for one or more scenes for inclusion in the generated algorithmic screensaver, such as the backgrounds behind scenes 602 and/or 604. In some embodiments, the background pattern, color and/or appearance of idle scenes and/or active scenes is independently controllable over the remaining aspects of the idle scenes and/or active scenes (e.g., which are optionally displayed over the background). Thus, in some embodiments, the electronic device selects a particular background for inclusion (or not) in the screensaver based on relevancy of that background to the context of the electronic device, as described herein. For example, if it is nighttime at the electronic device, the background is optionally chosen to be a dark background, whereas if it is daytime at the device, the background is optionally chosen to be a light background. In some embodiments, the chosen background is different for different components selected for inclusion in the particular scene. In some embodiments, the chosen background affects the visual prominence (e.g., brightness, color saturation, and/or transparency) with which one or more of the other components in the particular scene are displayed (e.g., different visual prominences for different backgrounds). Selecting backgrounds in the screensaver based on relevance ensures consistent and appropriate presentation of the screensaver, without the need for user input, and reduces computing resources needed to algorithmically generate the screensaver.

In some embodiments, the method includes detecting a second event (e.g., a user input, such as a click of a button or otherwise on a remote control device for the electronic device, or a swipe input on a touch-sensitive surface of the remote control device, such as an upwards or downward swipe) for displaying a screensaver selection interface at the electronic device, such as screensaver selection interface 603, wherein the screensaver selection interface includes a representation of a first screensaver for the electronic device, such as representation 632c, and a representation of the generated algorithmic screensaver for the electronic device, such as representation 632b. For example, the screensaver selection interface is displayed overlaid on the generated algorithmic screensaver. In some embodiments, the screensaver selection interface includes representations (e.g., images) of different available screensavers for display on the electronic device, such as previews of the content of the different screensavers. In some embodiments, one of the representations is a representation of the generated algorithmic screensaver.

In some embodiments, the method includes selecting one or more components for inclusion in the representation of the generated algorithmic screensaver based on relevancy to the context of the electronic device, such as selecting components for inclusion in representation 632b based on relevancy. Thus, in some embodiments, the electronic device selects components for inclusion in the representation of the generated algorithmic screensaver based on relevancy of those components to the context of the electronic device, as described herein. In some embodiments, the representation of the generated algorithmic screensaver can include any of the components of scenes described herein. In some embodiments, the representation of the generated algorithmic screensaver has one or more or all of the characteristics of scenes, as described herein. Selecting components for the representation of the generated algorithmic screensaver based on relevance ensures consistent and appropriate presentation of that representation, without the need for user input, and reduces computing resources needed to algorithmically generate the representation.

In some embodiments, the one or more components include positional states of an animated element (e.g., animated character(s), animated environmental elements (e.g., rain, clouds, trees, flowers, birds, sun, etc.)) in a respective scene (e.g., idle or active scene) of the generated algorithmic screensaver, such as the positional states of the characters in idle scenes 602 and/or 604. Thus, in some embodiments, the electronic device selects which character contexts or positions to include (e.g., the character dancing vs. the character sleeping vs. the character sitting on a chair) based on relevancy of those components to the context of the electronic device, as described herein. In some embodiments, three types of (optionally animated) positions are available for an animated character from which to select: base positions, additional positions, and character moments. In some embodiments, base positions and additional positions are loopable in playback (e.g., can be played back multiple times, sequentially, such as sleeping in different positions), and an interstitial component (e.g., animation) is available that can tie the end of one base position to the beginning of another base position (e.g., to be able to transition between those base positions). In some embodiments, additional positions are transitioned into from a base position, and out of into a base position. Example additional positions optionally include the character watching television, typing on a typewriter, or reacting to weather. In some embodiments, additional components (e.g., animations) are available that tie these additional positions into and out of a base position (or based positions)—in some embodiments, an additional position is predefined to begin at one particular base position and end at another (different) particular base position. In some embodiments, character moments also define a start at one particular base position and an end at another particular base position. In some embodiments, character moments are a one shot animations that do not loop in playback (e.g., cannot be played back multiple times, sequentially). Selecting component positional states based on relevance ensures consistent and appropriate presentation of such positional states, without the need for user input, and reduces computing resources needed to algorithmically generate the representation.

In some embodiments, the method includes selecting the positional states of the animated element in the respective scene based on a requested distribution of different types of positional states of the animated element for the respective scene, such as requested by a curation engine as illustrated in FIG. 6A, where the requested distribution of different types of positional states of the animated element for the respective scene is not based on relevancy to the context of the electronic device. In some embodiments, the distribution of the different types of positional states is defined by a curation engine (e.g., in the software performing method 700) that is optionally at a higher level than the relevancy engine described herein. In some embodiments, the curation engine defines the length (e.g., in time) of a particular idle scene, and defines the required distribution of the different types of positional states that should be selected for inclusion in the idle scene having that particular length. For example, the curation engine optionally indicates a required distribution, such as 60% base positions, 30% additional positions, and 10% in character moments, optionally distributed evenly with randomness (or distributed in another way) through the length of the particular idle scene. In some embodiments, the curation engine makes requests of the relevancy engine to provide component(s) of the screensaver, such as the positional states, and the relevancy engine responds with the selected component(s) (e.g., selected as described herein). For example, the request from the curation engine is optionally analogous to “give me the best (or most relevant) component of a particular type at this very moment”, and the relevancy engine responds with its determined best (or most relevant) component of the particular type for this very moment. The curation engine then optionally composites the components together to generate the screensaver. Selecting component positional states based on a framework of distribution ensures consistent and appropriate presentation of such positional states, without the need for user input, and reduces computing resources needed to algorithmically generate the representation.

It should be understood that the particular order in which the operations in method 700 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5C) or application specific chips. Further, the operations described above with reference to FIG. 7 are, optionally, implemented by components depicted in FIGS. 1A-1B. For example, detecting operation 702a, determining operations 702b, 702c, and selecting operation 702d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display user interfaces and/or information associated with devices in communication with an electronic device. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, images collected by devices etc.

The present disclosure recognizes that the use of such personal information data in the present technology can be used to the benefit of users. For example, the personal information data can be used to automatically perform operations with respect to suggesting representations of applications to incorporate into to a scrollable user interface. Accordingly, use of such personal information data enables users to enter fewer inputs to perform an action with respect to displaying and interacting with content. Further, other uses for personal information data that benefit the user are also contemplated by the present disclosure. For instance, user preferences may be used to identify smart home devices associated with the electronic device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain devices when detecting smart home devices associated with the electronic device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the algorithmic screensaver (or other content) can be generated based on aggregated non-personal information data or a bare minimum amount of personal information, such as the user preferences being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
detecting a first event for transitioning a generated algorithmic screensaver for an electronic device from a first scene to a second scene, different from the first scene;
determining a first scene type of the first scene;
determining a second scene type of the second scene; and
selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition.

2. The method of claim 1, wherein the visual effect is one or more of a sprite mask effect, a color dip effect or a crossfade effect.

3. The method of claim 1, wherein the first scene is associated with metadata that defines a first set of one or more permitted transition sequences for transitioning away from the first scene, the second scene is associated with metadata that defines a second set of one or more permitted transition sequences for transitioning into the second scene, and selecting the first transition sequences includes selecting the first transition sequence from an intersection of the first set and the second set.

4. The method of claim 3, wherein selecting the first transition sequence includes selecting the first transition based on a prior frequency of selection of the first transition sequence for use in the generated algorithmic screensaver.

5. The method of claim 3, wherein selecting the first transition sequence includes selecting the first transition based on a recency of prior selection of the first transition sequence for use in the generated algorithmic screensaver.

6. The method of claim 3, wherein the metadata associated with the first scene indicates one or more first categories of permitted transition sequences for transitioning away from the first scene, the first set of one or more permitted transition sequences are part of a category of the one or more first categories, the metadata associated with the second scene indicates one or more second categories of permitted transition sequences for transitioning into the second scene, and the second set of one or more permitted transition sequences are part of a category of the one or more second categories.

7. The method of claim 1, further comprising:
after presenting the first transition sequence for transitioning the algorithmic screensaver from the first scene to the second scene, presenting the second scene, including:
in accordance with a determination that the first transition sequence has a first value for a first transition property, presenting the second scene with a first value for a first scene property; and
in accordance with a determination that the first transition sequence has a second value for the first transition property, different from the first value for the first transition property, presenting the second scene with a second value for the first scene property, different from the first value for the first scene property.

8. The method of claim 1, further comprising:
after presenting the second scene and a second transition sequence for transitioning from the second scene to a third scene, wherein the third scene is of a same scene type as the first scene, presenting the third scene, including:
in accordance with a determination that the first transition sequence has a first value for a first transition property, presenting the third scene with a first value for a first scene property; and
in accordance with a determination that the first transition sequence has a second value for the first transition property, different from the first value for the first transition property, presenting the third scene with a second value for the first scene property, different from the first value for the first scene property.

9. The method of claim 1, wherein first scene and the second scene have scene types selected from: an idle scene type, or an active scene type.

10. The method of claim 1, further comprising:
while presenting the first scene of the generated algorithmic screensaver, wherein the first scene includes a first animated character that is presented with a first animation sequence, detecting a second event at the electronic device; and
in response to detecting the second event, presenting the first animation character in the first scene with a second animation sequence, different from the first animation sequence.

11. The method of claim 10, wherein the second event is a notification event at the electronic device.

12. The method of claim 10, wherein the second event is a smart home event at the electronic device.

13. The method of claim 10, wherein the second event is detection of a person at the electronic device.

14. The method of claim 1, further comprising:
selecting one or more components for inclusion in the generated algorithmic screensaver based on relevancy to a context of the electronic device.

15. The method of claim 14, wherein the context of the electronic device is based on one or more of: calendar data at the electronic device, weather data at the electronic device, content consumption data at the electronic device, or time of day at the electronic device.

16. The method of claim 14, wherein the relevancy of the one or more components is based on:
a prior frequency of selection of the one or more components for use in the generated algorithmic screensaver; and/or
a recency of prior selection of the one or more components for use in the generated algorithmic screensaver.

17. The method of claim 16, wherein:
in accordance with a determination that a respective component of the one or more components is a category of components:
a prior frequency of selection of the respective component for use in the generated algorithmic screensaver, and/or a recency of prior selection of the respective component for use in the generated algorithmic screensaver affect a relevancy of the respective component in a first manner, and
in accordance with a determination that the respective component of the one or more components is not a category of components:
the prior frequency of selection of the respective component for use in the generated algorithmic screensaver, and/or the recency of prior selection of the respective component for use in the generated algorithmic screensaver affect the relevancy of the respective component in a second manner, different from the first manner.

18. The method of claim 14, wherein the one or more components include one or more idle scenes for inclusion in the generated algorithmic screensaver.

19. The method of claim 18, wherein the one or more components include one or more components of one or more idle scenes for inclusion in the generated algorithmic screensaver.

20. The method of claim 19, wherein the one or more components of one or more idle scenes include one or more components that can be included in any idle scene of the generated algorithmic screensaver, and one or more components that can be included in a first subset of idle scenes of the generated algorithmic screensaver but cannot be included in a second subset of idle scenes of the generated algorithmic screensaver.

21. The method of claim 14, wherein the one or more components include one or more active scenes for inclusion in the generated algorithmic screensaver.

22. The method of claim 14, wherein the one or more components include one or more backgrounds for one or more scenes for inclusion in the generated algorithmic screensaver.

23. The method of claim 14, further comprising:
detecting a second event for displaying a screensaver selection interface at the electronic device, wherein the screensaver selection interface includes a representation of a first screensaver for the electronic device, and a representation of the generated algorithmic screensaver for the electronic device; and
selecting one or more components for inclusion in the representation of the generated algorithmic screensaver based on relevancy to the context of the electronic device.

24. The method of claim 14, wherein the one or more components include positional states of an animated element in a respective scene of the generated algorithmic screensaver.

25. The method of claim 24, further comprising:
selecting the positional states of the animated element in the respective cene based on a requested distribution of different types of positional states of the animated element for the respective scene, where the requested distribution of different types of positional states of the animated element for the respective scene is not based on relevancy to the context of the electronic device.

26. An electronic device comprising:
one or more processors;
memory; and
one or more programs, wherein the one or more programs are stored in the memory and configured to be executed by the one or more processors, the one or more programs including instructions for:
detecting a first event for transitioning a generated algorithmic screensaver for an electronic device from a first scene to a second scene, different from the first scene;
determining a first scene type of the first scene;
determining a second scene type of the second scene; and
selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition.

27. A non-transitory computer readable storage medium storing one or more programs, the one or more programs comprising instructions, which when executed by one or more processors of an electronic device, cause the electronic device to perform a method comprising:
detecting a first event for transitioning a generated algorithmic screensaver for an electronic device from a first scene to a second scene, different from the first scene;
determining a first scene type of the first scene;
determining a second scene type of the second scene; and
selecting a first transition sequence for transitioning the algorithmic screensaver from the first scene to the second scene based on the determined first scene type and the determined second scene type, wherein the first transition sequence defines a visual effect applied to at least a portion of the first scene and at least a portion of the second scene during the transition.
